(19) United States
(12) Patent Application Publication
(10) Pub. No.: US 2002/0119252 A1
(43) Pub. Date: Aug. 29, 2002

(54) Substance and process for producing sheath-like removable protective coating

(75) Inventor: Arthur Haycox, Shah Alam (MY)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ENVIROPEEL International Limited, Derehan (GB)

(21) Appl. No.: 09/991,160

(22) Filed: Nov. 21, 2001

Related U.S. Application Data
(63) Continuation-in-part of application No. 09/587,118, filed on Jun. 2, 2000, now abandoned.

(30) Foreign Application Priority Data
Jun. 4, 1999 (CH) 1999 1050/99

(51) Int. Cl. B05D 3/02

(52) U.S. Cl. 427/374.4; 427/374.5

(57) ABSTRACT

A substance and a method for creating a sheath-like protective coating (22). The substance is brought from a solid state into a liquid state, in which it can be sprayed on a surface (20), and after spraying it again returns into the solid state, wherein it forms a coherent body, free of perforations, of a high degree of toughness, whose cohesion is greater than its adhesion to the surface. The sheath-like protective coating (22) can be pulled off the surface (20) as a whole or at least in large sections. The substance is of such a nature that it can be repeatedly liquefied by the application of heat and solidified by the removal of heat. The sheath-like protective coating (22) can be used for the protection of an exterior surface, in particular a pipeline connection (11) at an oil drilling platform. In such a case, it forms a cocoon which encloses the pipeline connection.

### CROSS-REFERENCES TO RELATED APPLICATIONS

This is a continuation-in-part of U.S. patent application Ser. No. 09/587,118, filed Jun. 2, 2000.

### FIELD OF THE INVENTION

The invention relates to a substance and process for producing a sheath-like removable protective coating.

### BACKGROUND OF THE INVENTION

In structural engineering, as well as in connection with materials processing engineering, it is often not possible to produce parts for installations from materials which are sufficiently resistant to damaging effects, such as the damaging effects of corrosion. The reasons for this lie in the fact that sufficiently resistant materials cannot be used for reasons of production, shaping, sturdiness or price. The damaging effects to which installation parts can be subjected can be produced by the environment, as well as by the materials which are processed in the installations or used in connection with the function of the installations. Therefore, in many cases there is the necessity to provide surfaces exposed to such damaging influences with an appropriately resistant surface protection. Essentially two processes are known for this.

In connection with the first of these processes, the surfaces to be protected are provided with an adhering coating in the form of an impregnation or lacquer coating; the application of this protective coating takes place in that the appropriate agent, generally a liquid or paste, is applied to the surface to be protected, which can be performed, for example, by brushing or spraying the agent on or by dipping into the agent. The advantage of this process lies in that it can be performed relatively quickly and easily, wherein it is not only suitable for comparatively simple surfaces, such as flat surfaces, but that geometrically complicated surfaces can also be protected by it. However, the process has also very grave disadvantages. For example, it is hardly, or only with considerable outlay, possible to remove the protective coating from the surface to be protected, in particular, if the geometric shape of the surface is complicated. However, the removal of the protective coating is necessary in many cases, for example, if the protective coating has been mechanically or chemically attacked, be it because of wear, or because changes or repairs were performed on the parts to be protected. In this case, it is generally not possible to locally apply an additional coating of the protective fluid in the course of an additional coating process, because it would not adhere to the already existing coating. It is therefore necessary to remove the remainder of the still existing protective coating prior to re-coating, which generally is very costly. In many cases the protective coating cannot be mechanically removed, instead, solvents must be employed which, on the one hand, are expensive and, on the other hand, often have a character which is damaging to the environment. Finally, the removed protective coating constitutes waste, which is difficult to recycle.

In connection with the second of the processes for applying a protective coating to a surface, a coating of a solid material is applied to the surface to be protected. In case of surfaces to be protected which have a simple geometric shape, these can be panels, which are mounted with the aid of mechanical fastening elements or adhesives. Complicated surfaces, such as pipelines, for example, and particularly if these have flanges or tees with screw connections, however, are wrapped in flexible tape. These tapes, for example of a textile material, are generally soaked in impregnating agents, for example made of crude petroleum products. In case of surfaces protected in this way, it is not very difficult to remove them again when required, or to add to them. But the disadvantage of this process lies in that the application of the protective coating, i.e. wrapping the pipelines, requires very much time and cannot be mechanically performed. Problems arise in particular in places where the surface to be protected has irregularities, such as recessed or projecting parts. Moreover, removed tapes cannot be used again.

### SUMMARY OF THE INVENTION

It is therefore the object of the invention: (1) to provide a substance of the type mentioned at the outset, which avoids the above mentioned disadvantages and wherein a perfect protective coating made of it can not only be applied to any arbitrary surface, but can also be removed from this surface without problems, if required, and, (2) to propose a process for producing a sheath-like, removable protective coating made of this novel substance.

In accordance with the invention, the protective coating is produced by applying a suitable substance in fluid form to the surface to be protected. For this purpose, the substance, which originally is solid at ambient temperatures, is made into a fluid and applied to the surface to be protected, where it hardens. The application in fluid form can be simply performed and is also particularly suited for surfaces to be protected which have a complicated geometric configuration. However, the applied substance does not combine with the surface to be protected and instead, once it has hardened, forms a sheath-like protective coating, hereinafter called a sheath for short, in the manner of a coherent body, which covers, or respectively encloses the surface to be protected like a cocoon. After hardening, the substance from which the sheath is made forms a coherent, sealing body without unintended breaks and of considerable toughness. Although this sheath covers the surface to be protected and follows its shape, even in places where it has recesses and protrusions or makes abrupt changes in direction, it does not fuse with it, so to speak, or respectively bake on it. In any case, the tear resistance of the sheath, or respectively the cohesion of its substance, should be greater than the adherence of the sheath on the surface to be protected. When required, it is therefore possible to remove the sheath as a whole, or respectively in large sections without effort by peeling, or respectively pulling it off the surface to be protected. In the process, neither abrasive mechanical methods, such as grinding, nor chemical methods, such as the employment of solvents, need to be applied; because of this, unintentional damage to the surface when removing the sheath is also prevented. Moreover, it is a great advantage of the novel process that in the course of thermal or mechanical deformations of the surface to be protected, the sheath does not tear, but instead remains intact, since it is resilient and can possibly be slightly moved in relation to the surface to be protected; because of this, the service life of the sheath is greatly increased. The novel process is suitable for flat, as well as for simply or repeatedly curved surfaces of any arbitrary type, direction or dimension, as well as for outward- or inward-facing surfaces. For example, in the case of pipelines, an outer sheath is used against damage of the exterior pipe surface by environmental effects, while an interior sheath protects the pipe on the inside against damage by granulates, liquids or gases conveyed in it.

The application of the substance intended to form the sheath is advantageously performed by spraying.

Generally a substance, or respectively material, which can be changed to the fluid state by heating, is provided for forming the sheath, so that the use of solvents can be omitted.

It is particularly advantageous, both from the economic and the ecological point of view, to reuse the sheath which had been removed from the surface to be protected. This takes place in a simple way in that the material constituting the sheath is reheated and reapplied. It might be necessary to clean, i.e. wash, or respectively filter, the material constituting the sheath in the solid and/or liquid state. This has several advantages. On the one hand no new material is required for reconstituting the sheath, except if the amount of the still available and recycled material needs to be replenished. On the other hand, because the sheath is recycled, there is practically no waste which would have to be disposed of again at additional expense.

The nature of the substance from which the sheath is made depends on the respective intended use. In principle, the toughness of the substance should be greater than its adhesion on the surface to be protected. The properties of the surface to be protected, the surroundings, or respectively the chemical and mechanical effects exerted by them on the sheath, and the temperature at which the sheath is used, must be taken into consideration in the selection of a suitable substance. It is particularly advantageous if the substance is age-resistant, inter alia also in the sense that it can be repeatedly brought into the fluid state by beating and into the solid state by cooling.

In accordance with the invention, sheaths of this type are particularly suitable for sheathing pipelines and pipeline connections, such as are present in large numbers on oil drilling platforms. There, such pipeline connections are extremely endangered by corrosion, on the one hand, because of the surrounding salt-containing air and water sprays, even if they are outside of the seawater, and, on the other hand, by the seawater itself when they are immersed in it. Areas with screw connections are particularly subject to corrosion, since the screws and the flanges connected by them generally have different values in regard to the electrochemical series, so that they are subjected to strong bimetallic corrosion, wherein the salt-containing sea-water constitutes the respective electrolyte. The bimetallic corrosion is all the more intense, when the salt content of the seawater and the temperature are higher. However, this is completely and permanently stopped by the steps in accordance with the invention.

But it is pointed out that the invention is neither limited to the sheathing of pipelines nor to the use in connection with oil drilling platforms, but can practically be employed in all areas where surfaces must be protected from exterior influences, wherein of course the material intended for forming the sheath must be selected to match the respective circumstances.

### BRIEF DESCRIPTION OF THE DRAWINGS

Further details and advantages of the invention will be explained in what follows by means of exemplary embodiments and by making reference to the drawings. Shown are in:

FIG. 1, an exemplary embodiment of a sheath created in accordance with the process of the invention for protecting a pipe connection;

FIG. 2, a portion of FIG. 1 in an enlarged representation;

FIG. 3, a simplified schematic representation of the production of the sheath; and

FIG. 4, a simplified schematic representation of the process of the removal of the sheath.

### DETAILED DESCRIPTION OF THE INVENTION

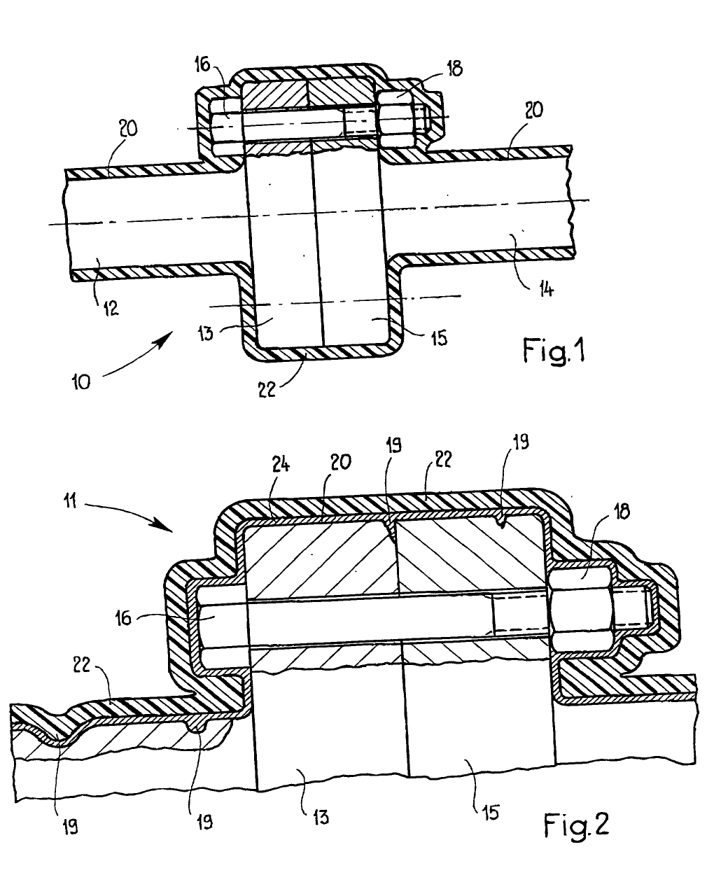

FIG. 1 represents a pipeline connection 10 of a first pipe 12 with a second pipe 14. On its end to be connected, the first pipe 12 has a flange 13, and the second pipe 14 has a flange 15 on its end to be connected. The two flanges 13, 15 are sealingly clamped together by means of threaded bolts 16 and nuts 18. Thus, the surface to be protected, on the one hand, comprises the exterior walls of the pipes 12, 14, the outward-facing circular, or respectively cylinder-jacket-shaped surfaces of the flanges 13, 15, as well as the outward-facing surfaces of the threaded bolts 16 and the nuts 18. The surface 20 to be protected is enclosed in a sheath 22, which sealingly sheathes the entire pipeline connection 10, wherein a sort of cocoon is formed, which exactly follows the contour of the surface 20. By means of this, the admission of water and air to the surface 20 is made impossible and therefore any corrosion is prevented.

The element 11 of the pipeline connection 10 represented in FIG. 2 shows how the substance constituting the sheath 22 fills even the smallest cavities 19 in the surface 20, so that even corrosion, which has already started, is stopped. Moreover, a corrosion inhibitor 24, which is deposited on the surface 20, reaches the pipeline connection 10 together with the compound forming the sheath 22.

Depending on the condition of the surface 20, it is recommended to clean it prior to applying the sheath 22, for example by means of a wire brush and, depending on the circumstances, to provide it with a primer.

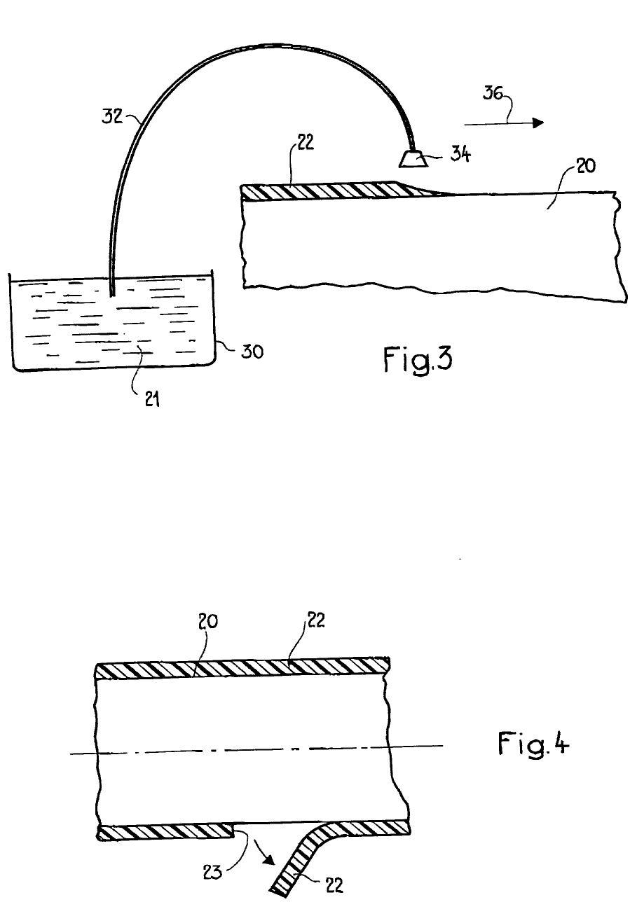

FIG. 3 schematically shows the application of the sheath 22 on the surface 20. For this purpose a substance 21 intended for forming the sheath 20 is heated in a heatable container 30 and liquefied, or respectively placed in a fluid state. It is subsequently conducted through a hose 32 to a spray gun 34 and finally, while the spray gun is moved 36 in relation to the surface 20, is sprayed on the surface 20, where it essentially is deposited in the form of the sheath 22 to be formed, and in the process follows the shape of the surface 20 precisely and very closely. The substance 21, or respectively the sheath 22, is solidified by cooling on the surface 20 and thereafter forms a coherent body, for example a sort of shell or skin wherein, however, no fusing or adhesion to, or respectively no baking on the surface 20 takes place. The sheath now is a resilient structure and therefore can follow heat or stress dilations of the material without breaking.

It might be that the sheath 22 needs to be replaced after a certain amount of time, either because it is worn off for any reason, or because the pipeline connection 10 needs to be opened or replaced. FIG. 4 shows the removal of the sheath 22. In this case, it is sufficient to perforate or cut open the sheath 22 at a place 23 along a short length—unless such a perforation does already exist and is the reason for performing the replacement of the sheath 22 -, after which the sheath 22 as a whole, or respectively large flat sections thereof, can be pulled off the surface 20.

The substance 21 of the former sheath 22 removed from the surface 20 can be reused. For this purpose it is again placed into the heatable container 30, if required after cleaning and comminution, where it is again liquefied by heating and is made sprayable in this way.

As mentioned above, different substances can be used for creating the protective coating. In what follows, the properties of a substance, which is available under the designation E170, will be described, which has shown itself to be particularly suitable for the protection of pipelines, flanges, stored machinery and machine components and others against atmospheric as well as against galvanic corrosion. This is a high-polymer, solvent-free coating substance, which can be peeled off and reused.

In a preferred form, this E170 substance is composed of the following ingredients in the approximate proportions shown:

| | Percentages by Weight |
|---|---|
| Mineral Oil | 61.8% |
| Paraffin Wax | 3.5% |
| Octyl-Phenol | 0.3% |
| Liquid Epoxy Resin | 0.3% |
| Ethyl Cellulose | 23.1% |
| Castor Oil | 11.0% |

The E170 substance has the following standardized values:

ASTM B117-97 3,000 hours resistance to salt fog

ASTM G62-87 Pinhole/Holiday test

ASTM G62-87 Dielectric value

ASM G53-96 Accelerated

The substance is honey-colored and translucent, but can be dyed any color.

The flash point is above 200° C.

As already mentioned, the substance is free of solvents, therefore does not contain any volatile organic components and no other harmful additives. Thus, 100% of the sprayable substance results in a solid sheath-like coating.

The substance contains suitable corrosion inhibitors, which after being sprayed on, are deposited between the surface to be protected and the sheath-like protective coating.

The substance moreover contains additives, by means of which it becomes peelable without a reduction of the adhesiveness.

Further additives have heat-stabilizing properties, for example.

The dielectric properties of the substance are such that no bimetal corrosion occurs between the sheath-like protective coating and the surface to be protected.

Suitable coating thicknesses are 1.0 to 1.5 mm/40 to 60 mil with normal corrosion, and 2.0 to 2.5 mm/80 to 100 mil with very aggressive corrosion.

During spraying, a coating thickness of 750 to 1,000 μm/80 to 100 mil can be achieved per passage.

The protective coating is dry to the touch in 1 to 2 minutes, can be oversprayed after 5 to 10 minutes and is sufficiently dry in 10 minutes so that components provided with it can be handled normally.

If a primer of the recommended type is employed, it can be oversprayed after 30 to 60 minutes.

The substance can be stored in the original packaging for 36 months at 20° C.

The temperatures to be maintained are approximately as follows:

| | |
|---|---|
| Melt temperature | 140° C./284° F. |
| Applications temperature | 170° C. to 175° C./338° F. to 344° F. |
| Maximum temperature | 180° C./212° F. |
| Maximum substrate temperature | 100° C./212° F. |

The following work is recommended for preparation:

at least treatment with a wire brush, removal of loose paint particles

normally additional washing with clear water, a primer coat

optimally abrasive high-pressure cleaning down to the bare metal, a primer coat.

A threefold protective effect is obtained by means of the above described substance:

Following solidification, the substance forms a sheath-like protective coating, which covers a surface to be protected completely and free of pores, or respectively encloses an object to be protected in a cocoon-like manner.

But if the sheath-like protective coating is perforated for any reason, by unintentional damage or by intentional manipulation of the objects to be protected, the corrosion inhibitor maintains its effect as a preventer of creeping corrosion, or respectively as a temporary protection.

If the sheath-like protective coating is completely removed, the corrosion inhibitor will be effective until a fresh protective coating is applied.

In the foregoing specification, the invention has been described with reference to specific preferred embodiments and methods. It will, however, be evident to those skilled in the art that various modifications and changes may be made, such as variations in the preferred E170 formulation, without departing from the broader spirit of the invention as set forth in the appended claims. The specification and drawings are, accordingly, to be regarded in an illustrative, rather than restrictive sense; the invention being limited only by the appended claims.

What is claimed is:

1. A method of applying to a surface a protective coating which will enshroud the contours of the surface to protect them from corrosion, the method comprising the steps of:
selecting for the coating material a resilient polymeric compound which incorporates a corrosion-inhibiting additive and which at ambient temperatures is initially solid, which liquefies when heated, and which resolidifies when subsequently cooled;
heating the material to a temperature sufficient to liquefy it;
coating the thus liquefied material onto the surface by spraying;
allowing the thus-sprayed coating to cool to form a sheath whose cohesion generally exceeds its adhesion to the surface and which can be pulled off from the surface and returned to the fluid state by further heating in order to be reapplied to the surface; and,
wherein the substance temperature, the spraying time, the coating thickness and the cooling time combine to cause the corrosion inhibitors to precipitate onto the surface during the solidifying step and form a protective film which will remain on the surface after the protective coating is removed.

2. The method in accordance with claim 1 further comprising the step of spraying the substance by successively applying coatings.

3. The method in accordance with claim 1 wherein said protective coating is formed from coating material which includes mineral oil, ethyl cellulose and caster oil.

4. The method in accordance with claim 2 further comprising applying each coating at a rate per passage of between 750 and 1000 μm.

5. The method in accordance with claim 2 further comprising a step of applying each further coating only when the previous one has dried.

6. The method in accordance with claim 2 further comprising a step of allowing the coating to dry for between 1 and 2 minutes.

7. The method in accordance with claim 4 comprising a step of allowing each coating to dry for between 1 and 2 minutes.

8. A method of applying to a surface a protective coating which will enshroud the contours of the surface to protect them from corrosion, the method comprising the steps of:
selecting for the coating material a resilient polymeric compound which incorporates a corrosion-inhibiting additive and which at ambient temperatures is initially solid, which liquefies when heated, and which resolidifies when subsequently cooled;
heating the material to a temperature sufficient to liquefy it;
coating the thus-liquefied material onto the surface by spraying in successive coatings, wherein each underlying coating is oversprayed after five to ten minutes;
allowing the thus-sprayed coating to cool to form a sheath whose cohesion generally exceeds its adhesion to the surface and which can be pulled off as from the surface and returned to the fluid state by further heating in order to be reapplied to the surface;
wherein the substance temperature, the spraying time, the coating thickness and the cooling time combine to cause the corrosion inhibitors to precipitate onto the surface during the solidifying step and form a protective film which will remain on the surface after the protective coating is removed.

9. The method in accordance to claim 8 further comprising the step of applying each coating at a rate per passage between 750 and 1000 μm.

10. The method in accordance with claim 8 further comprising applying each further coating only when the previous one has dried.

11. The method in accordance with claim 8 wherein said protective coating is formed from coating material which includes mineral oil, ethyl cellulose and caster oil.

12. The method in accordance with claim 8 further comprising the step of cleaning the peeled-off portions of the coating by washing or filtering prior to or following further heating.

13. The method in accordance with claim 8 further comprising the step of color-dying the substance.

14. The method in accordance with claim 8 further comprising the step of rendering the substance translucent.

15. The method in accordance with claim 8 further comprising the step of spraying the substance at a temperature within the range 170 to 175° C.
